(19) United States
(12) Patent Application Publication
(10) Pub. No.: US 2007/0088633 A1
(43) Pub. Date: Apr. 19, 2007

(54) Method and system for optimal or near-optimal selection of content for broadcast in a commercial environment

(75) Inventor: Mark Phillips, Seattle, WA (US)

Correspondence Address: OLYMPIC PATENT WORKS PLLC, P.O. BOX 4277, SEATTLE, WA, 98104, US

(73) Assignee: MOD Systems

(21) Appl. No.: 11/253,929

(22) Filed: Oct. 19, 2005

(51) Int. Cl. G06Q 90/00

(52) U.S. Cl. 705/28

(57) ABSTRACT

Many different embodiments of the present invention are directed to customizing and optimizing entertainment-content and information-content broadcast within retail establishments. In many embodiment of the present invention, an automated system employs a wide variety of different types of processed and compiled input information to compile and filter available content for broadcast, assign weights to the filtered, available content, and to continuously select content from the filtered and weighted. In a described embodiment, the automated system selects content for broadcast to optimally, or near-optimally, satisfy one or more goals established for the broadcast of entertainment content and information content within a retail establishment within a set of constraints.

### TECHNICAL FIELD

The present invention is related to broadcast of audio, visual, multi-media, and other content in commercial environments and, in particular, to a method and system for selecting content for broadcast that is optimal or near-optimal with respect to a set of goals.

### BACKGROUND OF THE INVENTION

Commercial enterprises, most particularly retail establishments, have, for many years, broadcast music, audio information, and other audio, video, and multi-media content to customers in order to entertain customers, inform customers of available and upcoming products and services, and to generally create an attractive environment within retail establishments. Retail establishments frequently contract with broadcast-music providers, such as Musak, for audio content, compile and broadcast music and other content themselves, or re-broadcast radio, television, or other broadcast entertainment and information. In some cases, retailers may interrupt broadcast music, or other broadcast content, in order to broadcast high-priority information or to customize broadcast information for the particular retail establishment. Unfortunately, these currently used techniques may provide less than satisfying entertainment and dissemination of information to customers, and may fail to provide an attractive and pleasing environment to customers of particular retail establishments. Moreover, management of retail-establishment broadcasts may represent a significant burden for retailers, and may provide little feedback or metrics to allow retailers to optimize entertainment and information broadcasts for particular purposes. For these reasons, content distributors, individual retailers, managers of retail outlets, and, ultimately, customers of retail establishments have all recognized the need for better methods and systems for broadcast of entertainment and information content within retail establishments.

### SUMMARY OF THE INVENTION

Many different embodiments of the present invention are directed to customizing and optimizing entertainment-content and information-content broadcast within retail establishments. In many embodiments of the present invention, an automated system employs a wide variety of different types of processed and compiled input information to compile and filter available content for broadcast, assign weights to the filtered, available content, and to continuously select content from the filtered and weighted content. In a described embodiment, the automated system selects content for broadcast to optimally, or near-optimally, satisfy one or more goals established for the broadcast of entertainment content and information content within a retail establishment within a set of constraints.

### BRIEF DESCRIPTION OF THE DRAWINGS

FIG. 1 illustrates a representative content-broadcast-management-system embodiment of the present invention.

FIG. 2 illustrates the general operation and intent of various content-selection systems of the present invention.

FIGS. 3A-D show control-flow diagrams that describe a content-selection method that represents one embodiment of the present invention.

### DETAILED DESCRIPTION OF THE INVENTION

Embodiments of the present invention are directed to automated systems for managing broadcast of entertainment and information content within retail establishments. System embodiments of the present invention employ continuously updated input information, defined constraints, and one or more defined goals in order to optimally or near-optimally select content for broadcast.

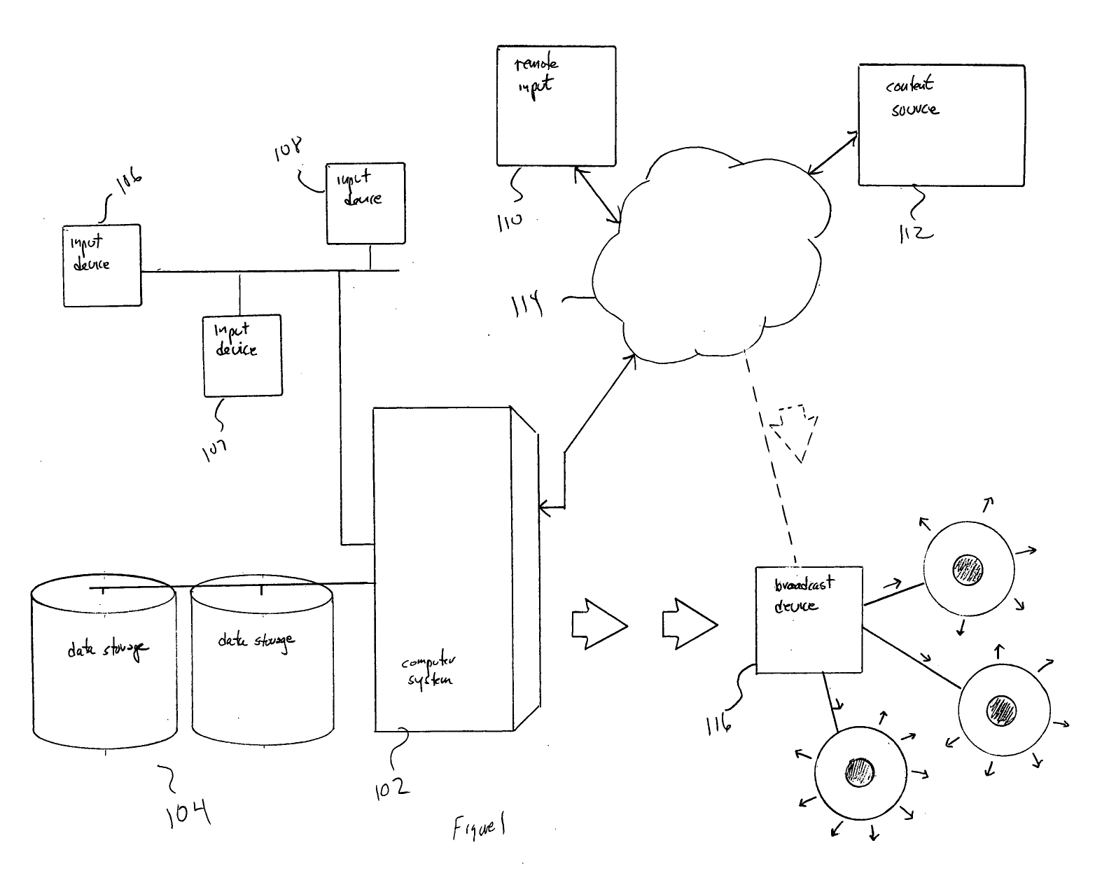

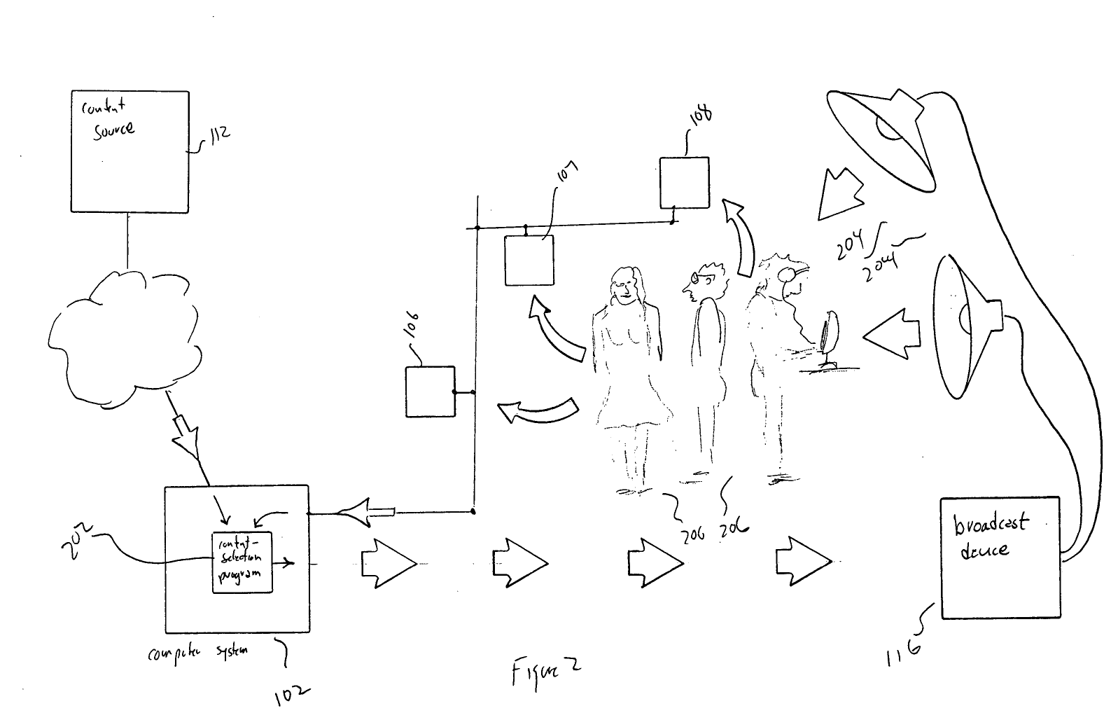

FIG. 1 illustrates a representative content-broadcast-management-system embodiment of the present invention. The system includes: (1) a computer system 102; (2) data-storage devices or systems 104 directly attached to, or accessible by, the computer system; (3) various types of data-input devices 106-108 directly attached to, or interconnected by one or more communications media with, the computer system; (4) one or more remote data input devices, such as remote data input device 110 interconnected through one or more communications media, such as the Internet, 114 to the computer system; (5) and one or more remote content sources, such as remote content source 112, interconnected through one or more communications media, such as the Internet, 114 to the computer system; and (6) a broadcast device 116 that broadcasts content to customers and staff within a retail establishment.

The computer system 102 may be a personal computer (“PC”), work station, or higher-end computer system used within a retail establishment for various management and control purposes. The computer system may also comprise multiple computer systems in a single retail establishment, or multiple computer systems in multiple retail establishments that are interconnected together in order to collectively manage two or more retail establishments. The computer system runs an automated content-selection program that, in certain embodiments, transmits content to a broadcast device for broadcast within a retail establishment and, in other embodiments, transmits references, or indications, of content to a broadcast device that independently acquires or accesses the referenced content. For example, the computer system 102 may download content from a remote content source 112, such as a centralized computing system, maintained at a home office or headquarters, for provision of content for broadcast in a number of retail establishments, and may store the downloaded content in a data-storage system 104 for subsequent transmission to the broadcast device 116. Alternatively, the computer system may acquire content from remote content sources and store the content on a content-distribution medium, such as a CD or DVD, which can then be manually transferred to the broadcast device. In yet a different embodiment of the present invention, the computer system may acquire content from remote content sources and download the content to memory or attached data-storage devices of a broadcast device 116. Alternatively, the computer system may simply send lists of references, or indications, of content to the broadcast device 116, which then, independently, acquires the content either from a remote content source 1 12 or from data-storage device 104.

The data-storage system or systems 104 store various processed and compiled input data used by the content-selection system and may store encoded constraints, goals, and other data used by the content-selection program executing on a computer system to optimally or near-optimally select the next content for broadcast. The data-storage system or systems may also store content for transmission to the broadcast device. Processed and compiled input data, constraints, goals, and other data may be transferred from the data-storage systems to memory of the computer system, as needed, during the content-selection process. In addition, certain input data may generally be stored in volatile memory of the computer system, without being persistently stored in the data-storage systems.

The input devices may include any number of different types of data-collection devices within a retail establishment. For example, input devices may include: (1) computerized cache registers; (2) order-entry and retailing devices, including music kiosks; (3) surveillance devices, such as video monitors; (4) information-input devices through which customers and staff may input personal information, suggestions, observations, and other information; and (5) various monitoring devices that monitor the entrance and exit of customers from the retail establishment, the presence of customers at various locations within the retail establishment, and various customer-related activities. The data collected by these input devices may be continuously transferred to the computer system, or transferred in compiled or partially compiled batches to the computer system, for processing and compilation by the computer system into encoded input data used by the computer system to select content for broadcast. The encoded input data may indicate, for example, the number of customers present in a retail establishment at each point in time during some previous time interval, demographic and personal information related to customers, indications of customer preferences and desires with respect to broadcast content, product and services availability, customer interests, data concerning the rate of sales of particular products at particular points in time during a previous time interval, data concerning the attractiveness of particular displayed information, kiosks, provided services, and other features within the retail establishment, and other data that may be useful in selecting content for broadcast within the retail establishment.

Remote input devices may include any of the above-discussed input devices in remote retail locations, and may additionally include centralized computer systems that compile and store constraint and rule criteria for content broadcast, as well as remote input devices that collect and transmit data concerning one or more retail establishments. Remote input devices may additionally include centralized, automated management centers and information systems.

Remote content sources 112 may include file servers, web servers, centralized data-storage services, and many other content sources that may be accessed by the computer system in order to acquire content for broadcast. Remote content sources may also include content-storage media, such as CDs and DVDs, remote computers or transmission devices that broadcast or feed content through any of numerous broadcasts or information-transmission media, and any other potential source for acquisition of content for broadcast within the retail establishment.

The broadcast device may be any of numerous audio, video, multi-media, or other content-broadcasting devices, such as amplifiers and loudspeakers, video-display monitors, projection equipment, and other such broadcast devices. As discussed above, the broadcast devices may store content received from either the computer system or from remote content sources, or may access content on an as-needed basis from the computer system, data-storage devices, remote content sources, or internally stored content-storage media, such as CDs and DVDs.

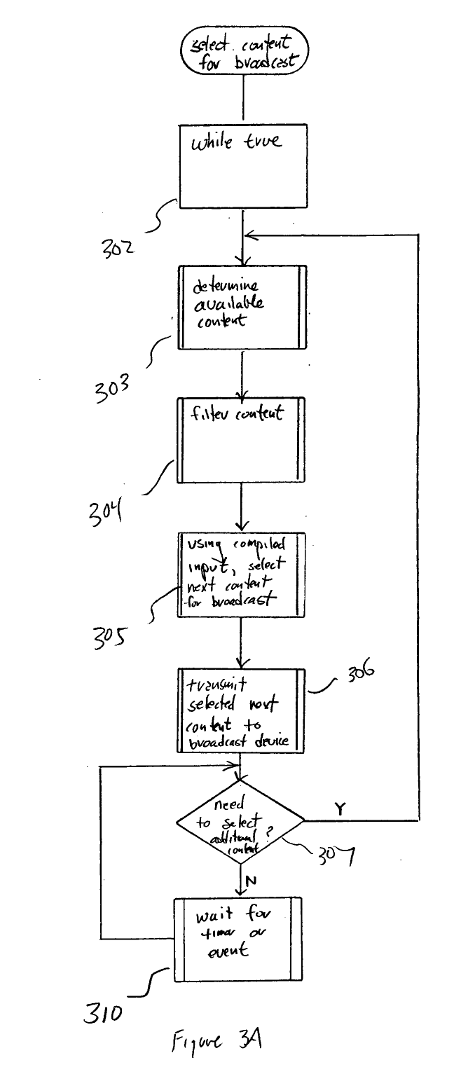

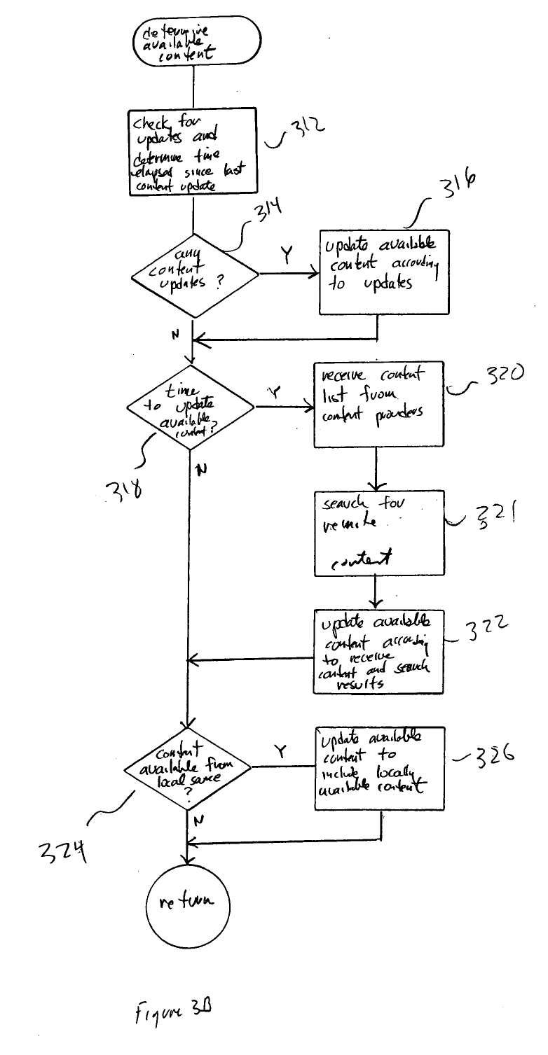

FIG. 2 illustrates the general operation and intent of various content-selection systems of the present invention. As shown in FIG. 2, content is continuously provided by a content-selection program 202 running within a computer system 102 to a broadcast device 116 for broadcast 204 to customers 206 within a retail establishment. The customers are entertained, leave and enter, purchase items through automated kiosks or at cash-register-equipped retailing stations, interact with staff, view product displays, and interact with one another, among other activities, in ways that can be monitored by various input devices 106-108. The data collected by the input devices is then transmitted back to the computer system, and used as input to subsequent content selection by the content-selection program. The content-selection program acquires content from remote content sources 112, locally stored content, or content stored in removal content-storage media, such as CDs and DVDs.

The content-selection program selects content in order to achieve certain goals, limited by certain constraints, which may be pre-defined, dynamic, or pre-defined and dynamically updated. Thus, customer behavior is continuously monitored, and content selected in order to satisfy customer needs and desires as well as retail-establishment goals. For example, the retail establishment may have a goal of selling as much holiday-related merchandize as possible within a period of time preceding a particular holiday. The content-selection program may acquire and filter content for broadcast related to the holiday, in addition to other content, and continuously refine selection of the holiday-related content and other content in order to maximize sales of holiday-related merchandize. It may turn out, for example, that reasonably constant broadcast of certain holiday-related content may lead to an increase in sales of holiday-related merchandize. However, it may also turn out that broadcast of holiday-related content may have the opposite effect, because customers have grown tired of holiday-related content broadcast in the retail establishment employing the content-selection program, or in other retail establishments or home environments. Therefore, although certain rules, indications, and principles may be employed in the content-selection process, actual monitoring and feedback is necessary in order to optimize content selection, particularly in dynamic retail establishments where users' needs, desires, and preferences may change on a daily or even hourly basis.

The content-selection problem is not trivial, and many different possible methods may be used to address the problem of content selection for broadcast in a retail establishment in order to achieve particular results, or to achieve a number of possibly conflicting results. For example, one may employ various statistical learning techniques, including hidden-Markov models and Bayesian-network techniques, neural networks, rule-based systems, inference engines, or combinations of all of these and other techniques in order to create a content-selection system that continuously learns to select content for broadcast in a retail establishment in order to achieve particular, specified goals. However, the content-selection problem perhaps most generally falls within the class of high-dimensional optimization problems, in which a large number of dynamic variables are continuously considered, along with various constraints, in order to select optimal or near-optimal trajectories, procedures, or variable values with respect to one or more goals. Such high-dimensional optimization problems are typically addressed by linear control theory, mathematical optimization theory, and other optimization methodologies.

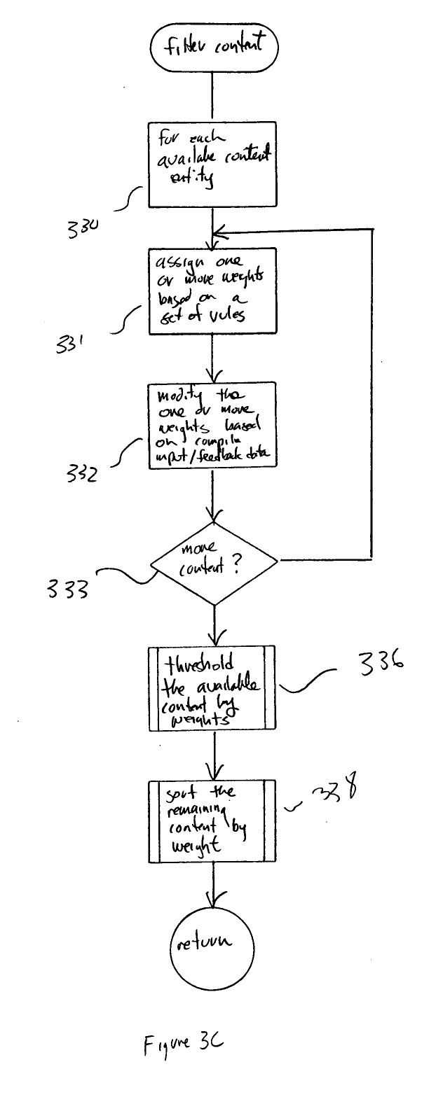

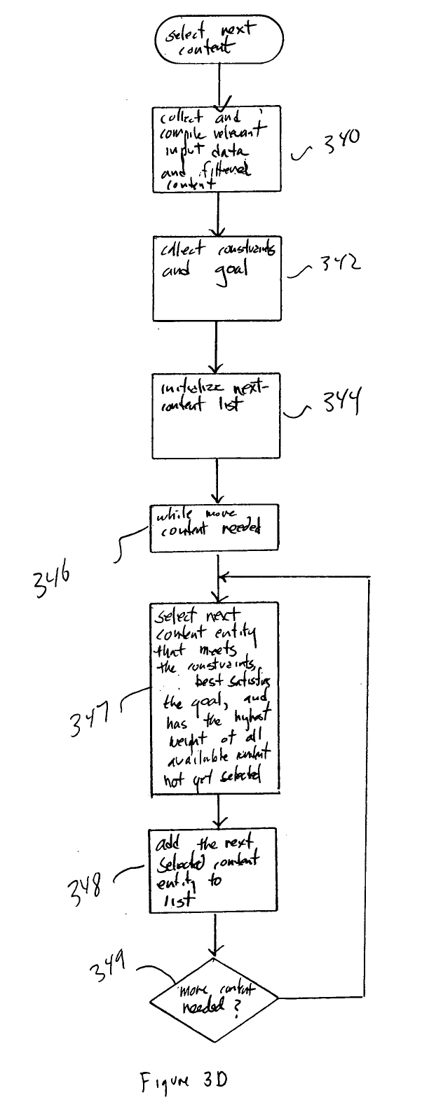

FIGS. 3A-D show control-flow diagrams that describe one content-selection method that represents one embodiment of the present invention. This described content-selection method represents one method that may be carried out by a content-selection program running within a computer system of a retail establishment to manage broadcast of entertainment and information content to customers and staff within the retail establishment.

FIG. 3A shows a high-level control-flow diagram for the program “select content for broadcast.” Steps 302-307 together compose a continuously iterated loop in which content is identified, accessed, filtered, and selected for broadcast by the select-content-for-broadcast program. In step 303, the select-content-for-broadcast program determines the available content from which the next content for broadcast is to be selected. In step 304, the select-content-for-broadcast program filters the available content in order to subsequently select content for broadcast from a filtered list or database containing only appropriate, acceptable, and desirable content. In step 305, the select-content-for-broadcast program uses encoded input information, stored constraints, and stored rules to select next content for broadcast from the filtered content prepared in step 304. In step 306, the select-content-for-broadcast program transmits the selected content to a broadcast device for broadcast to customers and staff within a retail establishment. If additional content needs to be immediately selected, as determined in step 307, control flows back to step 303. Otherwise, the select-content-for-broadcast program may set a timer, and then waits for timer expiration or another event, such as notification of a content, constraint, or rule update in step 310. If the timer expires, or an event occurs, control flows back to the decision step 307 in order to determine whether or not to select additional content for broadcast.

FIG. 3B shows a control-flow diagram for a routine “determine available content,” called in step 303 of FIG. 3A. In step 312, the determine-available-content routine checks any logs, data base tables, or other sources of stored information for updates to available content, and also computes the time elapsed since the last available-content update. If the determine-available-content routine determines, in step 314, that content updates are available, then, in step 316, the determine-available-content routine updates the list or database of available content to include the updated content detected in step 314. In step 318, the determine-available-content routine determines whether sufficient time has elapsed from a last content search to undertake a next content search. If sufficient time has elapsed, as determined in step 318, then, in steps 320-322, the determine-available-content routine accesses any content lists or data that have been received from content providers, such as a remote, centralized, content-provision source, searches for content that may be available from any number of remote content sources, and updates the list or database of available content to include the new, received content and new content found by searching. If, in step 320, the determine-available-content routine determines that content may be available from a recently supplied, local source, such as a CD or DVD, then, in step 326, the determine-available-content routine updates an available content list or database to include the new, locally available content.

FIG. 3C shows a control-flow diagram for the routine “filter content” called from step 304 in FIG. 3A. Steps 330-333 together compose a for-loop in which each content entity in a list or database of available content is evaluated for selection for broadcast. In step 331, the routine “filterContent” employs a set of rules, an inference engine, a neural network, a Bayesian network, a hidden-Markov model, or some other inference system or combination of inference systems to assign one or more weights to the currently considered content entity that represent the current, general desirability for broadcast of the content entity. Then, in step 332, the routine “filterContent” modifies the one or more weights based on compiled input data and feedback data, using any of various inference engines or rule-based systems, so that the modified weights express the desirability of broadcast of the currently considered content entity in the retail establishment under current conditions inferred to exist within the retail establishment, based on the compiled input data. For example, the inference rules employed in step 331 may include considerations of general current preferences and trends for entertainment content, such as current, most popular audio recordings, important promotional or informational messages, and other relatively static and non-particular-retail-establishment-specific criteria and parameters. These initially assigned weights may be then modified, in step 332, according to currently perceived conditions and characteristics of the retail establishment in which the content is to be broadcast. For example, it may have been determined that, at the particular time and day and year in which the currently selected content is to be broadcast, the retail establishment is almost exclusively visited by teenage customers. In that case, audio content that is highly weighted, in step 331, because of popularity with senior citizens may be down weighted, in step 332, to reflect the expected environment of the retail establishment at the time of content broadcast. Once all available content entities have been evaluated and weighted, in the for-loop of steps 330-333, the routine “filterContent” then thresholds the available content using one or more weight-value thresholds, in step 336, in order to subsequently consider only the most appropriate and desirable content from among the available content for consideration for selection in subsequent steps. This thresholding step essentially chooses, for subsequent consideration, the content items from the available content associated with one of more weights above a threshold weight, in the case that larger weights indicate more desirable content, or below a threshold weight, in the case that lower weights indicate more desirable content by comparing the weight or weights associated with each content item to threshold values. Then, in step 338, the filtered content is sorted, by weight, to facilitate subsequent selection.

FIG. 3D shows a control-flow diagram for the routine “selectNextContent” called in step 305 of FIG. 3A. In step 340, the routine “selectNextContent” collects and compiles all relevant input data, constraints, rules, and filtered content prepared by the routine “filterContent.” Next, in step 342, the routine “selectNextContent” collects any encoded constraints and goals that the routine “selectNextContent” needs to use in order to select next content for broadcast. Then, in step 344, the routine “selectNextContent” initializes a next-content list, file, database, or other storage vehicle to receive the next content selected in the while-loop of steps 346-349. While the routine “selectNextContent” needs to select additional content for transmission to the broadcast device, the routine “selectNextContent” selects a next content entity from the filtered list or database of content, in step 347, and adds the next content entity to the next-content list or other content-storage vehicle, in step 348. The while-loop of steps 346-349 continues until a sufficient amount of content is selected for the content-broadcast device. In some implementations, the routine “selectNextContent” needs only to select a single entity for broadcast during each invocation, and the program “selectContentForBroadcast” continuously executes in order to provide the most optimal content for broadcast at each point in time. In other implementations, the routine “selectNextContent” may select a fairly large batch of content for transmission to the broadcast device, such as a play list, CD or DVD, or other transmission vehicle, and the routine “selectContentForBroadcast” may only infrequently execute, as needed to supply batches of content for the broadcast device.

In step 347, the routine “selectNextContent” is step 347, in which the routine employs available data in order to select a next content entity from the list or database of filtered content. As discussed above, this step may be carried out by a wide variety of different artificially-intelligent inference engines, statistical-learning programs, rule-based systems, neural networks, or other such learning and inference engines that can draw inferences, or make decisions, based on a large amount of input information. In one embodiment, however, the selection of a next content entity may be accomplished by a largely mathematical optimization procedure. In such procedures, a goal, or set of goals, is mathematically encoded. The possible result set is generally considered to be a state space or hyperdimensional manifold, with local minima or maxima representing near-optimal or optimal result sets with respect to the mathematically expressed goals. The constraints may be employed to limit the volume of the state space, or surface of the hyperdimensional manifold, from which near-optimal or optimal result sets are selected, and the goal and constraints may both be employed to steer the optimization procedure towards local minima or maxima in an efficient manner, such as by a gradient-based steepest-descent procedure. Using a mathematical optimization technique, the routine “selectNextContent” can select a next content entity from the filtered list or database of content that best achieves the mathematically expressed goal or goals.

For example, the retail establishment may decide that its goal in broadcasting content to customers and staff is to achieve the greatest volume of sales, at any particular point in time, as well as to efficiently entertain customers so that the average length of stay for customers is 23 minutes. The retail establishment may have decided, from previous research, that 23 minutes is the optimal length of stay for customers in order to minimize the average amount of staff time devoted to each customer as well as to maximize exposure of the customer to offered products and services. The constraints may include prohibitions against broadcasting offensive material, preferences for broadcasting commercials and other advertising information sparingly, so as not to irritate customers, a strong preference for quickly broadcasting certain time-critical information as quickly as possible, and other such constraints. As discussed above, the compiled input data may include any number of different statistics and inferences regarding the number and types of customers expected to be in the store, the time of year and day, current products and services offered by the retail establishment, current trends and fashions, and a large variety of additional types of information. This input information defines the state space or hyperdimensional manifold, while the goals define a direction with respect to which particular result values are optimal, minimal, or have intermediate values.

Although the present invention has been described in terms of a particular embodiment, it is not intended that the invention be limited to this embodiment. Modifications within the spirit of the invention will be apparent to those skilled in the art. For example, as discussed above, the content-selection method and system of the present invention may be used locally, within a single retail establishment, over collections of two or more retail establishments, and may be controlled and modified by centralized, corporate management systems or may be essentially self-contained. As discussed above, any number of different types of statistical-learning engines, inference engines, rule-based decision systems, neural networks, or a wide variety of other decision and selection processes may be used to select content for broadcast based on input data and a list or databases of available content. A content-selection program embodiment of the present invention may be implemented in an essentially limitless number of ways, using different programming languages, control structures, data structures, modular organizations, and other such programming parameters. As discussed above, content may be compiled and distributed electronically, using content-storage media, such as CDs and DVDs, and in many other ways.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for selecting content for broadcast within a retail establishment, the method comprising:
continuously
processing and compiling input information characterizing the retail establishment;
filtering available content for broadcast; and
selecting next content for broadcast from the filtered, available content that is optimal or near-optimal with respect to one or more encoded goals.

2. The method of claim 1 wherein the input information is received through one or more input devices selected from among:
an electronic cash register;
an order-entry device;
a retail kiosk;
a surveillance camera;
sensors for detecting entry and exit of customers;
sensors for detecting removal of products from the retail establishment;
an information-input device devices through which customers and staff may input personal information, suggestions, observations, and other information; and
remote input devices that transfer information about the retail establishment through a communications medium.

3. The method of claim 1 wherein input information includes one or more of:
a number of customers present in the retail establishment at each point in time during a time interval;
demographic and personal information related to customers;
indications of customer preferences and desires with respect to broadcast content;
indications of customer preferences and desires with respect to product and services availability;
indications of customer interests;
data concerning the rate of sales of particular products at particular points in time during a time interval;
data concerning the attractiveness of particular displayed information, kiosks, provided services, and other features within the retail establishment;
information related to current trends in broadcast content; and
information related to current event, holidays, and other events that may effect product sales and customer interests.

4. The method of claim 1 wherein filtering available content for broadcast further includes assigning one or more weights to each currently available content entity, the weight representing a current, general desirability for broadcast of the content entity.

5. The method of claim 4 wherein weights are assigned by applying one or more of:
a set of rules;
an inference engine;
a neural network;
a Bayesian network; and
a hidden-Markov model.

6. The method of claim 4 wherein filtering available content for broadcast further includes modifying the one or more weights based on compiled input data and feedback data so that the modified weights express the desirability of broadcast of the currently available content entity in the retail establishment under current conditions inferred to exist within the retail establishment.

7. The method of claim 1 wherein selecting next content for broadcast from the filtered, available content that is optimal or near-optimal with respect to one or more encoded goals further comprises:
selecting one or more content entities that represent optimal content for broadcast based on optimization of the selected content with respect to one or more encoded goals and bounded by one or more encoded constraints.

8. The method of claim 1 wherein selecting next content for broadcast from the filtered, available content that is optimal or near-optimal with respect to one or more encoded goals further comprises selecting one or more weighted content entities by application of one or more of:
a set of rules;
an inference engine;
a neural network;
a Bayesian network; and
a hidden-Markov model.

9. A system broadcasting content within a retail establishment, the system comprising:
a broadcast system through which content is broadcast;
one or more input devices; and
a computer system that executes a program that continuously
processes and compiles input information received from the one or more input devices that characterizes the retail establishment,
filters available content for broadcast,
selects next content for broadcast from the filtered, available content that is optimal or near-optimal with respect to one or more encoded goals, and
directs the broadcast system to broadcast the selected next content.

10. The system of claim 9 wherein the one or more input devices are selected from among:
an electronic cash register;
an order-entry device;
a retail kiosk;
a surveillance camera;
sensors for detecting entry and exit of customers;
sensors for detecting removal of products from the retail establishment;
an information-input device devices through which customers and staff may input personal information, suggestions, observations, and other information; and
remote input devices that transfer information about the retail establishment through a communications medium.

11. The system of claim 9 wherein input information includes one or more of:
a number of customers present in the retail establishment at each point in time during a time interval;
demographic and personal information related to customers;
indications of customer preferences and desires with respect to broadcast content;
indications of customer preferences and desires with respect to product and services availability;
indications of customer interests;
data concerning the rate of sales of particular products at particular points in time during a time interval;
data concerning the attractiveness of particular displayed information, kiosks, provided services, and other features within the retail establishment;
information related to current trends in broadcast content; and
information related to current event, holidays, and other events that may effect product sales and customer interests.

12. The system of claim 9 wherein the program filters available content for broadcast by assigning one or more weights to each currently available content entity, the one or more weight representing a current, general desirability for broadcast of the content entity.

13. The system of claim 12 wherein weights are assigned by the computer program by applying one or more of:
a set of rules;
an inference engine;
a neural network;
a Bayesian network; and
a hidden-Markov model.

14. The system of claim 13 wherein the program filters available content for broadcast by further modifying the one or more weights based on compiled input data and feedback data so that the modified weights express the desirability of broadcast of the currently available content entity in the retail establishment under current conditions inferred to exist within the retail establishment.

15. The system of claim 9 wherein the program selects next content for broadcast from the filtered, available content that is optimal or near-optimal with respect to one or more encoded goals by:
selecting one or more content entities that represent optimal content for broadcast based on optimization of the selected content with respect to one or more encoded goals and bounded by one or more encoded constraints.

16. The system of claim 9 wherein the program selects next content for broadcast from the filtered, available content that is optimal or near-optimal with respect to one or more encoded goals by applying one or more of:
a set of rules;
an inference engine;
a neural network;
a Bayesian network; and
a hidden-Markov model.
